(19) United States
(12) Patent Application Publication
(10) Pub. No.: US 2018/0307231 A1
(43) Pub. Date: Oct. 25, 2018

(54) INTELLIGENT ELECTRONIC SPEED CONTROLLER (IESC)

(71) Applicant: 4D TECH SOLUTIONS, INC., Morgantown, WV (US)

(72) Inventors: Eric F. Sorton, Morgantown, WV (US); Marjorie A. Darrah, Grafton, WV (US); Bradley G. DeRoos, Fairmont, WV (US); Alex B. Rubenstein, Morgantown, WV (US)

(73) Assignee: 4D TECH SOLUTIONS, INC., Morgantown, WV (US)

(21) Appl. No.: 15/957,562

(22) Filed: Apr. 19, 2018

Related U.S. Application Data
(60) Provisional application No. 62/487,237, filed on Apr. 19, 2017.

(51) Int. Cl. G05D 1/02; B64C 39/02; G06N 3/08; G05D 1/00

(52) U.S. Cl. CPC G05D 1/0202; G05D 1/0055; G06N 3/08; B64C 39/024

(57) ABSTRACT

An intelligent electronic speed control (IESC) was developed that combines telemetry data from sensors on a small UAV with an intelligent rule set extracted from a trained artificial neural network (ANN) to detect and isolate faults and to predict future failures. IESCs integrated into the UAV's electronic architecture can serve to enhance UAV safety and reduce injury to personnel and damage to property by predicting failures and preventing accidents before they occur.

### CROSS REFERENCE TO RELATED APPLICATIONS

This application claims the benefit of U.S. Provisional Application No. 62/487237, filed Apr. 19, 2017, the contents of which are incorporated herein by reference.

### GOVERNMENT LICENSE RIGHTS

This invention was made with government support under contract number NNX17CC27P awarded by the National Aeronautics and Space Administration (NASA). The government has certain rights in the invention.

### FIELD OF INVENTION

This application relates to unmanned aerial vehicles (UAVs), and more specifically it relates to electronic speed controls for UAVs.

### BACKGROUND

An electronic speed controller (ESC) is an electronic circuit that can be used to vary an electric motor's speed and direction, and possibly also may function as a dynamic brake.

ESCs are often used on electrically powered radio controlled UAVs, with the variety most often used for brushless motors essentially providing an electronically generated three-phase electric power low voltage source of energy for the motor. An ESC can be a stand-alone unit that plugs into the receiver's throttle control channel or it can be incorporated into the receiver itself, as is the case in most toy-grade R/C vehicles. Some R/C manufacturers that install proprietary hobby-grade electronics in their entry-level vehicles, vessels or aircraft use onboard electronics that combine the two on a single circuit board.

Small UAV multirotor aircraft use four, six, eight, or more motors oriented vertically in a symmetrical configuration to support vertical take-off and landing (VTOL). A distinction between a multirotor aircraft and a fixed wing aircraft is that a multirotor has no control surfaces. By varying the power of different motors, the multirotor aircraft controls pitch, roll, and yaw. For example, a quadrotor pitches forward by increasing power to the two rear motors while decreasing power to the two forward motors. Controlling the power of each motor is paramount to successful multirotor flights. The failure of a motor or ESC is devastating as the forces on the multirotor are no longer balanced and control is lost. This typically results in a crash. Multirotors with six, eight, or more motors offer some redundancy and may be able to recover from a motor failure if supported by the control system, but recovery is not a given, with pilot skill playing a significant role in UAV recovery.

Multirotor aircraft use ESCs to control the power delivered to each motor. One ESC controls one motor. ESCs sense the position of the motor via back electromotive forces (EMF) and pulse power across motor poles to control both rotation direction and speed. ESCs typically monitor temperature, voltage, and current. If current or temperature exceeds a preset or user-configurable limit or if voltage drops below a preset or user-configurable limit, the ESC generally stops commanding the motor. Most ESCs have no way to provide feedback to the user, thus, no warning of a failure is provided to the user. The first indication of a problem is loss of power and, as noted above, loss of control. In addition, in most cases, the operator has little insight into the cause of the failure.

ESC design deficiencies relate to the history of development; most multirotor ESCs are derived from hobby ESCs previously used to fly fixed wing aircraft. These ESCs needed to be compatible with existing R/C equipment and receive the same signal received by R/C servos, a simple pulse width modulation (PWM) signal received at a rate of 20 milliseconds with a 1.0 to 2.0 millisecond pulse width. The width of the pulse specifies the desired position of the servo or motor command. This control method, including the signal rate and pulse width, was developed in the early 1960s by NASA. To improve control, some multirotor ESCs have increased the update rate of the PWM signal from the original 20 milliseconds. Thus, the primary inputs to an ESC are battery power and the PWM control signal; the primary output is the power to the motor. Most modern ESCs have no digital communications back to the flight control system to report problems. As a result, there is a need in the industry for an improved electronic speed control that can monitor data from multiple sensors and detect faults and predict failures based on the observed data.

### SUMMARY

The present invention solves the foregoing problems by providing an electronic speed control (ESC) that can: (1) perform self-monitoring to detect faults and predict future failures before they impact system performance, and (2) predict the system life cycle and degradation over the dynamic operational life of a system.

One aspect of the invention is a method for predicting future failures of an unmanned aerial vehicle (UAV) including the steps of obtaining telemetry data from at least three electronic speed controls onboard the UAV, wherein each of the electronic speed controls is in communication with at least one sensor; and applying a rule-based system to the telemetry data from the sensors onboard the UAV to generate an output to detect faults in the UAV and to predict future failures.

A second aspect is an unmanned aerial vehicle (UAV) electronic speed control system having one or more electronic speed controls onboard the UAV; one or more sensors in communication with each of the electronic speed controls; and a processor in communication with the one or more sensors and the one or more electronic speed controls, wherein the processor is configured to: obtain data from the one or more sensors onboard the UAV; and apply a rule-based system to data obtained from the sensors to generate an output to detect faults in the UAV and to predict future failures.

A third aspect is a non-transitory computer-readable storage medium with instructions stored thereon to detect faults in an unmanned aerial vehicle (UAV) and to predict future failures of the UAV, the instructions including: obtaining telemetry data from one or more sensors on each of at least three electronic speed controls on the UAV; and applying a rule-based system to the telemetry data from the sensors onboard the UAV to generate an output to detect faults in the UAV and to predict future failures.

A fourth aspect is a method for predicting future failures of an unmanned aerial vehicle (UAV) including the steps of obtaining telemetry data from one or more sensors onboard the UAV; training an artificial neural network; extracting a rule set from the trained artificial neural network; and applying the rule set to the telemetry data from the one or more sensors onboard the UAV to detect faults in the UAV and to predict future failures.

This application relates to the development of an intelligent electronic speed control (IESC) that combines telemetry data from sensors on a small UAV with an intelligent rule set extracted from a trained artificial neural network (ANN) to detect and isolate faults and to predict future failures. IESCs integrated into the UAV's electronic architecture as described herein can serve to enhance UAV safety and reduce injury to personnel and damage to property by predicting failures and preventing accidents before they occur.

One of the many possible uses of an IESC is where two or more electronic speed controls (ESCs) are used within the same system allowing a comparative analysis between the ESCs. Examples of such systems included multirotors, e.g., quad, hex, octo, etc., multi-engine model aircraft, and future full scale aircraft using multiple engines.

One of the many possible features of at least one embodiment of an IESC of the present invention is an ESC with both internal and external sensors.

Another feature is that the ESCs can communicate sensor data either to each other or to a processor.

Another feature of the invention is that it examines sensor data from one or more ESCs and predicts current and future performance.

The IESC optionally also can include a supervisory processor to receive and analyze data from the ESC, additional printed circuit boards to collect additional sensor data used as part of the analysis, non-volatile read only memory or other memory to store collected data, and cloud based computers to collected IESC data from multiple platforms. The IESC of the present invention is an enhancement over current ESCs as it provides: improved reliability and performance of small UAVs by predicting failures; increased safety of small UAVs by detecting faults prior to an in-flight incident; improved mission success by ensuring vehicle health prior to start of flight; decreased maintenance costs by detecting issues prior to flight thus preventing loss of a small UAV; and predicted failures across families of small UAVs based upon historic performance data.

The present invention can be used to reduce the occurrence of loss of control accidents that may result in human injury and property loss (e.g. both the UAV and property impacted on the ground). In addition, the invention allows operators to maintain and operate their UAVs in a highly professional manner that is consistent with best-practices in other industries where machinery failure can cause harm to humans or damage property.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates one of many possible embodiments of a fully integrated electronic speed control system of the present invention;

FIG. 2 illustrates one of many possible embodiments of a telemetry-enabled electronic speed control;

FIG. 3 illustrates one of many possible embodiments of a supervisory processor;

FIG. 4 is a table with neural network and rule accuracies for a testing set for an unbalanced propeller;

FIG. 5 is a table with neural network and rule accuracies for different combination of parameters, percentage of failures correctly identified (flagged failures), and percentage of failures which the rules determined by the neural network could not classify into any rule set (unclassified failures);

FIG. 6 is a graph that shows percentage of unclassified data points for 10 nodes. Rule sets were implemented with data collected from nominal (85, 86, 88) and failure (94, 96, 98) runs to determine the percentage of unclassified; and

FIG. 7 is a graph that shows percentage of unclassified data points for 5 nodes.

### DETAILED DESCRIPTION

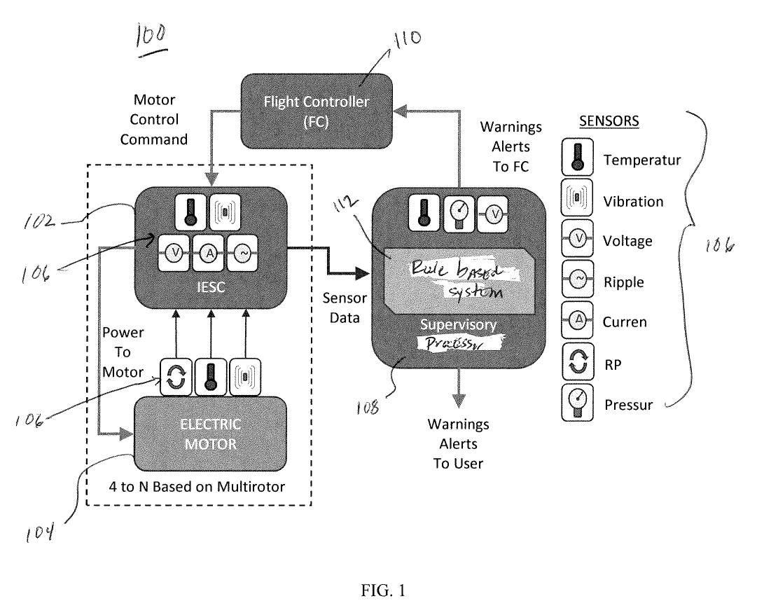

Referring generally to FIG. 1 there is shown one of many possible embodiments of an unmanned aerial vehicle (UAV) electronic speed control system 100. The electronic speed control system 100 includes one or more sensors 106 onboard the UAV, one or more electronic speed controls 102 for each UAV motor 104, and a supervisory processor 108 in communication with the one or more sensors 106 and the one or more electronic speed controls 102. Each electronic speed control 102 can collect internal sensor data on itself as well as external sensor data on the motor 104 it is controlling. The supervisory processor 108 collects data from the one or more sensors 106 and the electronic speed controls 102, and applies a rule-based system 112 to the collected data to detect faults in the UAV and to predict future failures. Data and instructions from the supervisory processor 108 also can be transmitted to a flight controller 110 to control the flight characteristics of the UAV.

As defined and used herein, “rule based system” refers to human-crafted or curated rules sets, and it also can include rule-based systems constructed using automatic rule inference, such as rule-based machine learning, as a subset or genus of rule based systems. Non-limiting examples of machine learning can include supervised learning, clustering, dimensionality reduction, structured prediction, anomaly detection, neural nets, and reinforcement learning.

In one of many possible alternative embodiments, there may be no supervisory processor 108, and the rule based system 112 can be executed on each individual electronic speed control 102. Each electronic speed control 102 can receive sensor data from all other electronic speed controls 102 in the electronic speed control system 100 using a digital bus, for example, a CAN bus. Each electronic speed control 102 can be responsible for determining its own health, as well as the health of the other electronic speed controls 102. Each electronic speed control 102 can be responsible for reporting its calculated health to the flight controller 110 or to the operator.

Telemetry enabled electronic speed controls 102, also referred to as intelligent electronic speed controls (IESCs), can send sensor data to the supervisory processor 108 or to other electronic speed controls 102. Sensor data can include data from sensors 106 internal to the electronic speed control 102, and also can include data from sensors 106 attached to the motor or additional sensors 106 external to the electronic speed control 102. Non-limiting examples of sensor data collected by an electronic speed control 102 can include: motor temperature (external thermistor attached to motor); motor RPM (external rotational sensor attached to motor); motor vibration (external accelerometer attached to motor); electronic speed control temperature (internal thermistor on electronic speed control circuit board); battery voltage (measured internal to the electronic speed control); current (measured internal to the electronic speed control); ripple voltage (measured internal to the electronic speed control); RPM (as measured by the electronic speed control); throttle command (as received by the electronic speed control). The electronic speed control 102 can send its telemetry data via the selected communications method.

For the electronic speed control system 100 to function, the electronic speed controls 102 must communicate sensor data either between themselves or with a central supervisory processor 108. Common communication architectures, such as point-to-point or bus based, can be applied to the electronic speed control system 100. In a point-to-point or star topology, each electronic speed control 102 communicates directly with the supervisory processor 108. There is a one-to-many relation between the supervisory processor 102 and electronic speed controls 102. In this communications architecture, the supervisory controller 108 is required and has a single connection for each electronic speed control 102. Additional sensors 106 can only be added to the system by directly connecting them to the supervisory processor 108. The point-to-point communications architecture could be implemented with underlying protocols such as RS232serial or Serial Peripheral Interface (SPI). In this architecture, electronic speed controls 102 do not communicate directly with each other.

In a bus based topology, each electronic speed control 102 communicates on a bus. All components on the bus can see communications with all other components. In this communications architecture, a supervisory processor 102 may be used, but is not required. Additional sensors are easily added by attaching them to the communications bus. The bus communications architecture could be implemented with underlying protocols such as CANBus. In this architecture electronic speed controls 102 can communicate directly with each other. Other communications architectures may be possible.

The method for predicting future failure of a UAV can operate on several different sets of data. Each of these data sets serves a different purpose in helping predict and detect failures. The data sets can include: real-time data; historical data; vendor data; and cloud data. The method for predicting future failure of a UAV can have several possible implementations, such as, basic limit checking, trend analysis, and application of a rule-based system, such as an intelligent rule set generated by an artificial neural network.

The supervisory processor 108 can use real-time sensor data from one or more electronic speed controls 102 or motors 104 to analyze current performance and to predict failures. By examining the current state of each electronic speed control 102 or motor 104 in comparison to the others, the electronic speed control system 100 can recognize if the performance of one motor or electronic speed controls 102 is degraded relative to the others. For example, if one of the screws holding one of the motor mounts loosens and causes the motor mount to rotate on the the resulting rotation of the motor 104 will unbalance the forces exerted by the motors 104 and likely result in a crash. The electronic speed control system 100 may be able to detect and prevent such a failure by analyzing vibration signature of each arm/motor 104. As the screws loosen, the vibration experienced by the failing motor mount will change with respect to the other arms. The electronic speed control system 100 would detect this signature change by comparing the vibration profiles of each motor 104 as it occurs and alerting the operator of the issue.

In another example, if a motor bearing is failing, an astute operator may observe a change in the pitch emitted from the failing motor 104. In a noisy environment, the change may go unnoticed. The bearing may also fail silently. A failing bearing will result in increased friction. Increased friction will increase the power required to operate the motor 104 at a given RPM. This will lead to an increase in motor 104 temperature and an increase in current. An increase in both temperature and current with respect to other motors 104 could be an indication of a failing motor 104.

As an operator flies the multirotor, the supervisory processor 108 collects sensor data and records baseline performance. Sensor data is collected, analyzed, averaged, and fused with ambient conditions to establish baseline performance parameters of each electronic speed control 102 and motor 104. Once sufficient data has been collected to establish a baseline, the supervisory processor 108 can monitor the current sensor data to ensure it is within expected parameters. With historical data, the supervisory processor 108 learns the expected performance of the vehicle and evaluates performance against that baseline.

Looking back to the previous example of the motor bearing failing, the indication of a failure is even clearer if historical data stored within the supervisory processor 108 showed the motor 104 operated at a similar temperature compared to the other motors 104 in the past. The proposed system could detect these changes and alert the operator of the issue.

Similarly, a vendor integrating an electronic speed control system 100 into a product could further enhance the ability of the electronic speed control system 100 to detect faults and failures by providing the electronic speed control system 100 with ideal performance data. The vendor performs systems tests to establish the expected performance of the multirotor. This baseline performance can be loaded into the electronic speed control system 100 prior to delivery to a customer as the ideal or expected performance. The electronic speed control system 100 can then extend its analysis to include comparison of both current and historical data to the ideal data provided by the vendor.

Vendor data will also allow the electronic speed control system 100 to predict system life-cycle and estimate degradation of performance. Vendor data could include performance of the multirotor UAVs both as delivered and as it ages. By comparing current and historical data to the vendor data, the electronic speed control system 100 can estimate the life-cycle degradation of the system.

Another possible iteration extends the ability of a vendor to further analyze and predict performance by leveraging the cloud. If each multirotor is able to upload its historical performance data to the cloud, a vendor would have a significantly larger data set with which to establish ideal or expected conditions. In addition, the vendor could use this data set to analyze failures and to provide additional data for the electronic speed control system 100 to predict future failures. For example, a vendor could execute an artificial neural network on a larger data set producing a refined intelligent rule set. The electronic speed control system 100 could potentially receive the updated intelligent rule set from the vendor further refining the expected performance and improving the detection of faults and failures.

Simple limit checking is a possible method for analyzing the sensor data to ensure all sensors 106 remain within their maximum expected values. More complicated methods may be needed to detect more subtle failures and to predict future failures.

Trend analysis can be used to detect faults and to predict failures. “Trend analysis” is the widespread practice of collecting information and attempting to spot a pattern, or trend, in the information. In some fields of study, the term “trend analysis” has a more formally defined meaning. Although trend analysis is often used to predict future events, it could be used to estimate uncertain events in the past, such as how many ancient kings probably ruled between two dates, based on data such as the average years which other known kings reigned.

To develop an intelligent set of rules, an artificial neural networks (ANN) can be used for data analysis. The knowledge from the ANN can be extracted in the form of a rule set that can be trusted and implemented in the electronic speed control system 100 to provide a powerful data-driven, computational tool able to capture the nonlinear complexities underlying characteristics of the electronic speed control system 100 with a high degree of accuracy. Electronic speed control system 100 sensor output during bench testing and/or test flights can be used as initial input to the ANN. An initial training set can be developed to include flight data of normal non-eventful flights and flights where known faults that can lead to failure have been introduced. The ANN can process the data and then an initial rule set can be extracted. This rule set can be implemented in the electronic speed control system 100 and be used to predict failures and provide warning to the operator.

Advantages of using ANNs with rule extraction are that: 1) the nonlinear model is easy to use and understand compared to statistical methods, 2) ANNs are designed to work with complicated problems such as this where there are many input variables and the relationships of those input variables under a range of normal operational and fault scenarios is complex, and 3) the rules provide a way to extract the knowledge so it can be examined by the user for validation and implemented in a system. An ANN is a non-parametric model while most statistical methods are parametric models that need higher levels of statistics to be effective. The ability to quickly learn from training data will be beneficial as there are numerous systems integrators and manufacturers of UAVs that do not have time to develop data sets of the size needed for other processing methods. ANN training is enhanced by imposing known boundary conditions related to the electronic speed control system 100, e.g., current, voltage, temperature.

A feed-forward ANN with a back propagation (BP) learning algorithm could aid in classification and forecasting of faults. Combining rule extraction functionality allows the knowledge of the ANN to be presented to the system user and manufacturer. Incorporating rule extraction will lead to better human interpretation of faults and failure modes. When performing analysis of complex data, one of the problems stems from the number of variables involved; rule extraction will result in the constructing combinations of the variables to get around the problems associated with complex connections that are not easily understood, while still describing the data with sufficient simplicity for human interpretation.

In one of many possible embodiments, the supervisory processor 108 collects real-time sensor data from the electronic speed controls 102. The supervisory processor 108 also optionally stores historical data and ideal vendor test data. The supervisory processor 108 can analyze the input data to detect UAV faults and to predict failures. Inputs to the supervisory processor 108 can include current sensor data, historical sensor data, and ideal vendor test data. The supervisory processor 108 determines and outputs the health of each electronic speed control 102. Non-limiting examples of sensor data collected by the supervisory processor 108 can include ambient temperature; ambient pressure; and vibration (accelerometer on circuit board).

Additional sensor information may be required other than the information provided by the electronic speed controls 102. The electronic speed control system 100 may include additional printed circuit boards that collect additional sensor data. In addition, the electronic speed control system 100 could also collect sensor and flight information from the flight controller on the electronic speed control system 100.

In order to perform trend analysis, the electronic speed control system 100 should be able to store historical data. Non-volatile read only memory (NVROM) or another storage technology may optionally be included on either the electronic speed controls 102 or the supervisory processor 108. This data storage can be used to store historical data and/or vendor data that aids in the fault analysis and failure prediction.

The electronic speed control system 100 also may have a cloud component. The cloud component would allow the electronic speed control system 100 to upload performance data to a computer in the cloud. Additional analysis would be performed in the cloud to further refine the parameters of the fault analysis and prediction. The cloud component could then provide updated information to the electronic speed control system 100 to further refine the fault detection and failure prediction.

### EXAMPLE

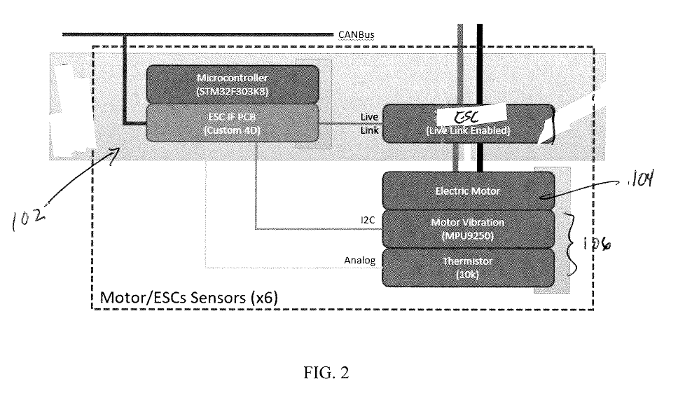

FIG. 2 is a block diagram of an exemplary telemetry-enabled electronic speed control 102 of the present invention. The IESC Interface (IF) Printed Circuit Board (PCB) can be combined with the microcontroller, IESC IF PCB, and motor control functionality provided by a commercially available ESC, as shown in the figure, into a single integrated unit. Sensor data collected by the telemetry enabled electronic speed control 102 includes: motor temperature (external thermistor attached to motor); motor vibration (external accelerometer attached to motor); electronic speed control temperature (internal thermistor on electronic speed control circuit board); battery voltage (measured internal to the electronic speed control); current (measured internal to the electronic speed control); ripple voltage (measured internal to the electronic speed control) RPM as measured by the electronic speed control; and throttle command as received by the electronic speed control).

As an example of the implementation, a supervisory processor collects, collates, and analyzes the sensor data gathered by each telemetry enabled electronic speed control as well as collects non-electronic speed control data required for vehicle health and management.

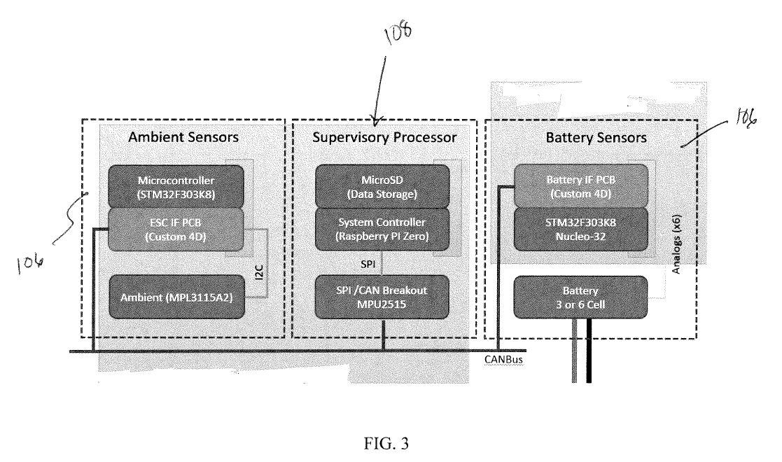

FIG. 3 shows a block diagram of the supervisory processor. The ambient sensor and supervisory processor components can be combined, as shown in the figure, into a single integrated unit as with the Battery IF PCB and development board. A general-purpose, Raspberry Pi Zero W processor was used in lieu of a microcontroller. The general-purpose processor allowed for implementation of the supervisory process software in Python. Open-source mathematical analysis extensions, NumPy and SciPy, were installed to Python. The use of a 5th generation language and mathematical extensions significantly enhanced the speed of development of the supervisory processor software. An additional microcontroller was added to the system to collect ambient pressure and temperature.

A common failure mode of the lithium-polymer batteries used in small UAV systems is single battery cell failure. A cell monitor allows us to monitor and record individual cell voltages. These cell voltages could be used to develop rule sets for predicting battery failure. Another microcontroller can be added to the system to perform battery monitoring. A custom Battery IF PCB can be developed due to the number of voltage dividers required to support six-cell batteries.

The ambient sensors, battery sensors, and the electronic speed control sensors all communicate with the supervisory processor via CANBus running at 250 kbit/s and with the capability of running faster if required. Due to the bus implementation, only two data lines are required for communications between components simplifying wiring. The selected microcontroller board includes a CANBus implementation. A CANBus transceiver was added to the PCB boards.

In order to develop the fault prediction method, an artificial neural network (ANN) was trained and a rule set capable of detecting failures of the motor subsystem of a small UAV was extracted. A comprehensive set of flight data was collected, properly formatted and scaled. The neural network was designed and adapted to facilitate rule extraction. The chosen neural network was trained on pre-processed data for analysis and subsequent rule extraction. The intelligent rule set was built and implemented in the electronic speed control system 100.

### Processing the Training Data

Time series data was collected from the sensors on each motor and included the output from the gyroscope in the x, y and z directions and the output from the accelerometer in the x, y, and z directions. The data sets were collected over an extended time with and without failures being introduced.

Data sets were pre-processed to more manageable sizes for training of a neural network. The time series data was reduced to several valuable parameters that would provide information about the shape of the curve being represented. The time series data were collected and each data run was reduced to an n-dimensional vector. Some of the vectors represented good or nominal data and some represented failure data. The parameters of mean, standard deviation, kurtosis, root mean square, and skew were used for both accelerometer and gyroscope data in each of the x, y and z directions.

The time series data from the motors' sensors were typically collected over five and ten minute intervals. The data was divided into 30 second intervals in order to provide more data vectors for training the neural network. Each 30 seconds of time series data from an individual motor sensor (accelerometer and gyroscope) was converted to a single vector. If the motor had a fault introduced, then the vector was flagged as a failure, appending a 1 to the vector, otherwise it had a 0 appended to the vector. Thus, the data sets created consisted of hundreds of 31-dimensional vectors (5 parameters in 3 axes times 2 sensors, plus the flag), some of which represented failure data and some nominal data. These would provide training and testing sets for the neural network.

### The Neural Network

After determining the type of data to be used, it was decided to use a Self-Organizing Map (SOM) neural network called the Dynamic Cell Structure (DCS) neural network. The DCS neural network was designed as topology representing network whose role is to learn the topology of an input space. The DCS partitions the input space into Voronoi regions. The neurons within the neural network represent the reference vectors (centroids) for each of the Voronoi regions. The connections between the neurons are then part of the Delaunay triangulation connecting neighboring Voronoi regions through their reference vectors.

The DCS algorithm consists of two learning rules, Hebbian and Kohonen. These two learning rules allow the DCS neural network to change its structure to adapt to inputs. The ability to adjust neuron positions and add new neurons into the network gives the DCS neural network the potential to evolve into many different configurations. Unlike other SOMs, the DCS does not start with a grid of nodes, but the implementation starts with just two nodes and then the user can choose how large the network should grow. The trade-off between size and accuracy; if the neural network grows too large it can be “over trained” to the input data and if it grows too few nodes, it may not be able to classify with much accuracy. The challenge is to find the balance between optimal size and accurate classification of the input.

### Rule Extraction

A neural network is often thought of as a “black box” meaning that just looking at the structure produced by the neural network itself does not explain what it has learned. The purpose of rule extraction is to extract the knowledge that the neural network has learned in a more understandable format, so it may be examined. The main reasons for using rule extraction are for better understanding of the learning and for also developing fixed rules that can be implemented in a system that perform like the neural network after training.

The rule extraction technique used for the DCS neural network generates rules called “human understandable” because the output is a set of rules in the form of if/then statements that involve the input parameters. If the output (after the THEN) is a 0, then this indicates no failure; if the output is a 1, then this indicates a failure.

### Implementing and Testing Rules

Several experiments were run with the DCS to determine the ideal size for the neural network (number of nodes or cells) and the best subset of training parameters that would generate the most accurate rules. Since the user can set the size (number of nodes) of the DCS, it was important to determine what number of nodes would yield the most accurate set of rules; each node is related to a rule.

The first test was conducted using data collected running a quadcopter without failures and then running it with one unbalanced propeller. The data were processed and the 31-dimemisional vectors explained above were developed for each 30 seconds of data from each motor sensor. The first test used the 30 parameters from the accelerometer and the gyroscope as independent variables and the failure flag as the dependent variable. Tests were run to allow the number of nodes developed by the DCS to vary; it was tested at 250 200, 150, 100, 75, 50, 25, 15, 10, and 5 nodes. The DCS was trained on 75% of the data and tested on the remaining 25% of the data.

These first tests produced accurate rules in many cases using all the parameters. This was the first indication that the DCS using the processed data would be able to divide the data into nominal and failure cases. The next step was then to determine the smallest size (number of nodes) and the fewest number of parameters that could be used to produce good results. Since the goal is to implement the rule set in the system, the fewer parameters and the fewer rules, the less processing time needed. Limiting the number of nodes also potentially develops a neural network that will generalize better to new data sets and not be “overtrained” to one particular set of data.

Once the initial rule sets were determined, the next step was to implement these rules for testing in a simulation. The simulation was used to determine how the rules would function at detecting failures in real-time. The implemented rule sets produced similar results as were predicted with the training data set processed through the simulator but were less accurate with new data being processed through the simulator. This was to be expected, since in order to be able to generalize to any data, the training set will need to be more diversified, meaning that many test runs with nominal and failure data will need to be combined to form the training set. However, this first test showed that the DCS was able to separate the failures from the nominal data at a very high rate, so the challenge was now to find the best set to use for training, the best size for the DCS, and the best set of parameters to reveal each failure.

The second test involved using different sets of parameters and fixing the network growth to 10 nodes (10 rules). From this test several sets of variables were identified that would produce optimum classification results. The third test involved using different sets of parameters and fixing the network growth to 5 nodes (5 rules). From this test several sets of variables were identified that would produce optimum classification results. The fourth test involved combining two different runs to collect more nominal and failure data and create a combined set. After these tests were completed for the unbalance propeller failure, the same methods were applied for two more failure types: a clipped propeller and a loose arm mount.

To test the rule sets, a playback script was developed that would read the raw CANBus archive file saved during data collection runs. The playback script is identical to the data collection script (shared software) except that the data source is a playback file as opposed to the CANBus device. The playback script allowed rule sets to be tested quickly; a five-minute test run could be rerun and analyzed in several seconds on a desktop PC. This enabled the quick testing of rule sets, varying of script parameters, and providing of feedback for continued neural network development.

In the final phases of testing, additional test runs of both nominal and failed data were conducted. These test runs were not used to train the neural network. The data from these test runs were run through the playback script to ensure the rule set would detect failures from data runs that it did not train on.

### First Test—Determining Maximum Number of Nodes

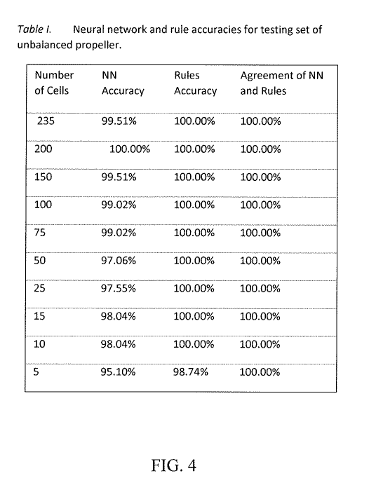

Initial testing was conducted with a set of nominal and failure data for a single unbalanced propeller (UBP) to determine the number of nodes that produced the highest percentage accuracy without “overtraining” the neural network. It was determined that the smallest number of nodes to allow were at 10 and 5 nodes as both showed greater than 95% accuracy at classification. Accuracy percentages are provided in FIG. 4.

### Second Test—Variable Combinations at 10 Nodes

Different combinations of independent variables were then tested with a maximum number of allowed nodes set to 10. The sets of variable combinations found to have the highest classification accuracies are provided in Table II. Percentages of flagged failures (true positives) and data points which were not classified are also provided.

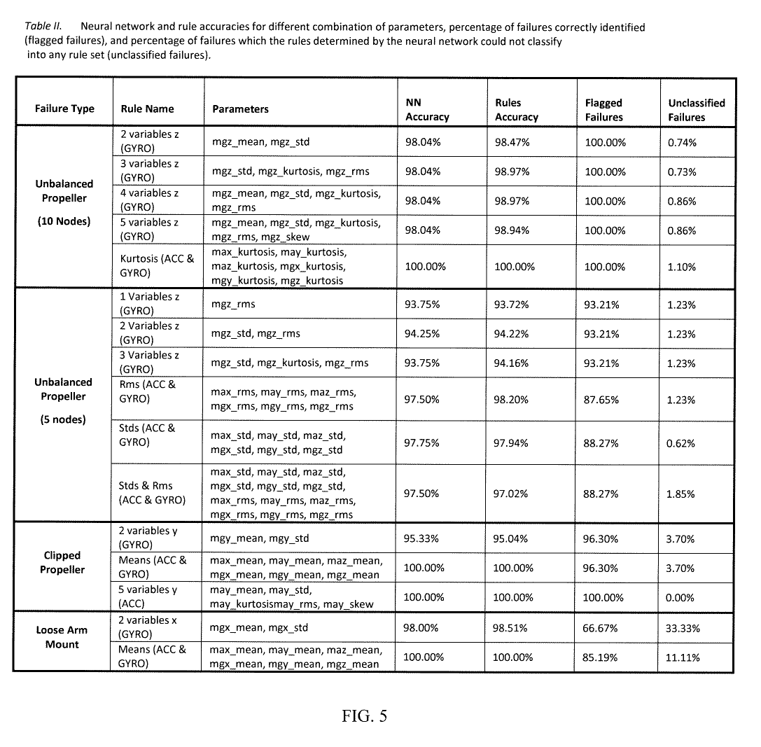

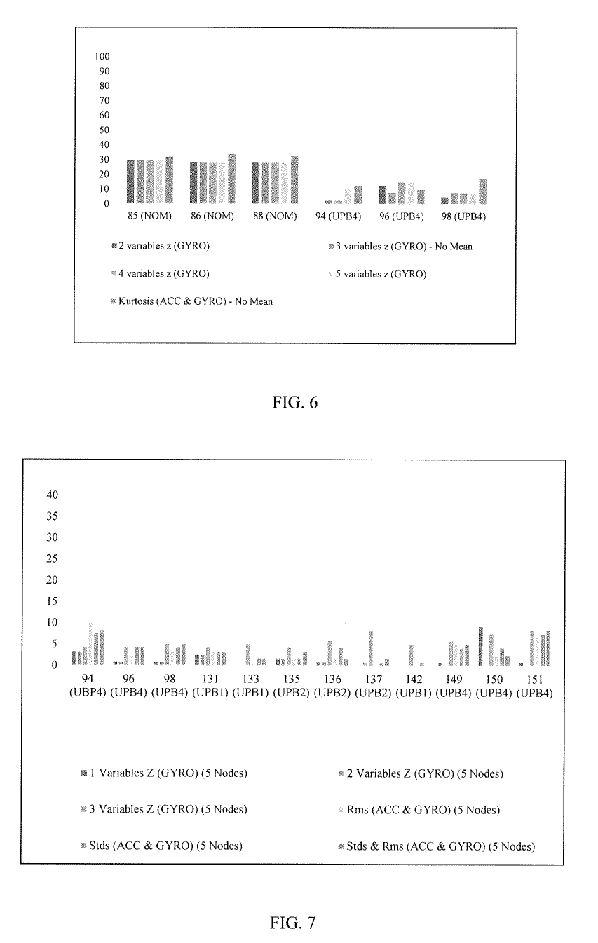

The rule sets shown in FIG. 5 were implemented with new data runs of both nominal and failure cases in the simulation described above. It was found that the rule sets generated for 10 nodes were not as accurate when tested against new data. As shown in FIG. 6, the number of unclassified points was much higher than observed in a single set of UBP data. Hence, rules were generated with a maximum allowance of 5 nodes for more generalized rule sets. Additionally, another set of data for an unbalanced propeller was combined with the original to provide more data points to train the neural network.

### Third Test—Variable Combinations at 5 Nodes

Accuracy of two sets of UBP data was obtained with a maximum allowance of 5 nodes. This allowed for comparison to the accuracies obtained at 10 nodes.

Additionally, analysis of two different sets of UBP data was conducted to determine if similar sets of parameters would be found to have the highest accuracies. The percentages of these sets, denoted UBPa and UBPb, was found to be similar. However, the highest percentage of flagged failures was found to be 85% in UBPa and 78% in UBPb. Additionally, the percentage of unclassified failures was >6%.

### Fourth Test—Combined UBP Sets at 5 Nodes

After combining two sets of UBP data together, the sets of parameters that resulted in the highest rule accuracies were determined for a maximum allowance of 5 nodes and are provided in FIG. 5. Analysis of each set of UBP data at 5 nodes showed the percentage of flagged failures ranged from 70-85% for the most accurate combinations of variables. Upon combination of the two sets, the percentage of flagged failures was found to increase to >88%. Additionally, the percentage of unclassified points was reduced to less than 2% in the combined set. The rule sets were implemented in the simulation to test new data of both nominal and failure test runs. It was found that unclassified data from failure runs was less than 10% and often less than 1%, as shown in FIG. 7 below.

### Analysis of Different Failure Types

Additional failure types consist of a clipped propeller and a loose arm mounting. Both failure types were analyzed according to the same iterative process as described above for the unbalanced propeller. For both the clipped propeller and loose arm mount, it was determined that a maximum allowance of 5 nodes provided the best accuracy percentages for all parameters. Combination of variables were tested to determine the most accurate sets. The percentages for these sets of variables are provided in FIG. 5 for both failure types.

### CONCLUSION

While various embodiments of the present invention have been described above, it should be understood that they have been presented by way of example only, and not limitation. It will be understood by those skilled in the art that various changes in form and details may be made therein without departing from the spirit and scope of the invention. Thus, the breadth and scope of the invention should not be limited by any of the above-described exemplary embodiments.

What is claimed is:

1. A method for predicting future failures of an unmanned aerial vehicle (UAV), comprising:
obtaining telemetry data from at least three electronic speed controls onboard the UAV, wherein each of the electronic speed controls is in communication with at least one sensor; and
applying a rule-based system to the telemetry data from the sensors onboard the UAV to generate an output to detect faults in the UAV and to predict future failures.

2. The method of claim 1, further comprising transmitting the output to a flight controller to modify UAV flight control algorithms.

3. The method of claim 2, wherein the flight controller is onboard the UAV.

4. The method of claim 1, further comprising obtaining historical data pertaining to the UAV's performance and applying the rule-based system to the historical data.

5. The method of claim 1, further comprising obtaining vendor data pertaining to the UAV's performance and applying the rule-based system to the historical data.

6. The method of claim 1, wherein the at least one sensor is internal to the electronic speed control.

7. The method of claim 1, wherein the rule-based system is a rule-based machine learning method.

8. The method of claim 8, wherein the rule-based machine learning method is an artificial neural network.

9. An unmanned aerial vehicle (UAV) electronic speed control system, comprising: one or more electronic speed controls onboard the UAV; one or more sensors in communication with each of the electronic speed controls; and a processor in communication with the one or more sensors and the one or more electronic speed controls, wherein the processor is configured to: obtain data from the one or more sensors onboard the UAV; and apply a rule-based system to data obtained from the sensors to generate an output to detect faults in the UAV and to predict future failures.

10. The UAV electronic speed control system of claim 9, wherein the process is further configured to obtain historical data pertaining to the UAV's performance and to apply the rule-based system to the historical data.

11. The UAV electronic speed control system of claim 9, wherein the process is further configured to obtain vendor data pertaining to the UAV's performance and to apply the rule-based system to the historical data.

12. The UAV electronic speed control system of claim 9, wherein the rule-based system is a rule-based machine learning method.

13. The UAV electronic speed control system of claim 12, wherein the rule-based machine learning method is an artificial neural network.

14. The UAV electronic speed control system of claim 9, wherein the processor is further configured to modify UAV flight control algorithms in response to the output.

15. A non-transitory computer-readable storage medium with instructions stored thereon to detect faults in an unmanned aerial vehicle (UAV) and to predict future failures of the UAV, the instructions comprising: obtaining telemetry data from one or more sensors on each of at least three electronic speed controls on the UAV; and applying a rule-based system to the telemetry data from the sensors onboard the UAV to generate an output to detect faults in the UAV and to predict future failures.

16. A method for predicting future failures of an unmanned aerial vehicle (UAV), comprising:
obtaining telemetry data from one or more sensors onboard the UAV;
training an artificial neural network;
extracting a rule set from the trained artificial neural network; and
applying the rule set to the telemetry data from the one or more sensors onboard the UAV to detect faults in the UAV and to predict future failures
